(19) United States
(12) Patent Application Publication
(10) Pub. No.: US 2025/0200437 A1
(43) Pub. Date: Jun. 19, 2025

(54) COMPUTER-READABLE RECORDING MEDIUM STORING SELECTION PROGRAM, SELECTION DEVICE, AND SELECTION METHOD

(71) Applicant: Fujitsu Limited, Kawasaki-shi (JP)

(72) Inventor: Thang Duy DANG, Yokohama (JP)

(73) Assignee: Fujitsu Limited, Kawasaki-shi (JP)

(21) Appl. No.: 18/925,187

(22) Filed: Oct. 24, 2024

(30) Foreign Application Priority Data
Dec. 18, 2023 (JP) 2023-212615

(51) Int. Cl. G06N 20/00

(52) U.S. Cl. CPC G06N 20/00

(57) ABSTRACT

A non-transitory computer-readable recording medium stores a selection program for causing a computer to execute processing including: obtaining a relaxed structure of a substance from an initial structure of the substance by numerical calculation; and selecting an intermediate structure of which a difference between energy of the intermediate structure and energy of the relaxed structure is less than a predetermined value, from among a plurality of the intermediate structures of the substance, obtained in a calculation process to obtain the relaxed structure, as training data used to train a machine learning model that estimates energy of a predetermined structure from the predetermined structure of the substance.

### CROSS-REFERENCE TO RELATED APPLICATION

This application is based upon and claims the benefit of priority of the prior Japanese Patent Application No. 2023-212615, filed on Dec. 18, 2023, the entire contents of which are incorporated herein by reference.

### FIELD

The embodiment discussed herein is related to a selection technology for selecting training data of a machine learning model.

### BACKGROUND

Structural optimization is a technique for optimizing a molecular structure of a substance. Density functional theory (DFT) calculation may be used, in the structural optimization. The DFT calculation is one of first-principles quantum chemical calculations for approximately calculating an electron density of a molecule, and can efficiently calculate electronic properties of the molecule.

Regarding the DFT calculation, a training device that trains a model of a neural network potential (NNP) has been known. A method of ranking energy of molecule crystals using the DFT calculation has been known.

International Publication Pamphlet No. WO 2022/260177, International Publication Pamphlet No. WO 2022/260179, and U.S. Patent Application Publication No. 2007/0185695 are disclosed are related art.

### SUMMARY

According to an aspect of the embodiments, a non-transitory computer-readable recording medium stores a selection program for causing a computer to execute processing including: obtaining a relaxed structure of a substance from an initial structure of the substance by numerical calculation; and selecting an intermediate structure of which a difference between energy of the intermediate structure and energy of the relaxed structure is less than a predetermined value, from among a plurality of the intermediate structures of the substance, obtained in a calculation process to obtain the relaxed structure, as training data used to train a machine learning model that estimates energy of a predetermined structure from the predetermined structure of the substance.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional configuration diagram of a selection device according to an embodiment;

FIG. 2 is a flowchart of selection processing;

FIG. 3 is a functional configuration diagram of a training device;

FIG. 4 is a diagram illustrating a change in total energy;

FIG. 5 is a flowchart of training processing;

FIG. 6 is a diagram illustrating the number of pieces of training data;

FIG. 7 is a diagram illustrating an estimation error ER;

FIG. 8 is a diagram illustrating a change in the estimation error ER; and

FIG. 9 is a hardware configuration diagram of an information processing apparatus.

### DESCRIPTION OF EMBODIMENTS

By performing structural optimization using DFT calculation, a relaxed structure can be obtained from an initial structure of a molecule of a substance via a plurality of intermediate structures. The relaxed structure is an optimized molecular structure of the substance. In the structural optimization, total energy of a molecular structure is minimized, and a position of each atom is repeatedly adjusted, so as to stabilize the molecular structure. In the relaxed structure in which the total energy is minimized, all atoms are arranged at equilibrium positions.

However, calculation cost of the DFT calculation is significantly high, and the DFT calculation takes long time. Therefore, a DFT proxy model may be used, as an alternative unit with lower calculation cost and higher speed than the DFT calculation. The DFT proxy model is a trained model generated by machine learning and is used to estimate the total energy from the molecular structure of the substance.

Since estimation accuracy of the DFT proxy model largely depends on the number of pieces of training data, and in a case where the DFT proxy model is trained using a small number of pieces of training data, the estimation accuracy is considerably lower than the estimation accuracy of the DFT calculation. Therefore, in order to improve the estimation accuracy, it is desirable to train the DFT proxy model using a large number of pieces of training data.

However, the training data of the DFT proxy model is generated by the DFT calculation, and a combination of the relaxed structure obtained by the DFT calculation and the total energy of the relaxed structure is used as the training data. Therefore, when the DFT calculation as many times as the number of pieces of training data is repeated, to generate a large number of pieces of training data, calculation cost for generating the training data increases.

Note that such a problem is caused not only in the DFT calculation but also in a case where the training data is generated using various numerical calculations.

In one aspect, an object of the embodiment is to increase the number of pieces of training data of a machine learning model that estimates energy from a structure of a substance.

Hereinafter, an embodiment will be described in detail with reference to the drawings.

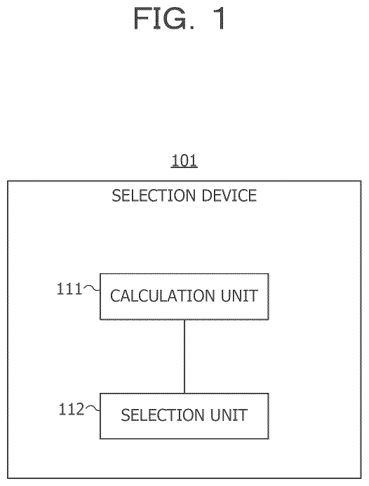

FIG. 1 illustrates a functional configuration example of a selection device according to the embodiment. A selection device 101 in FIG. 1 includes a calculation unit 111 and a selection unit 112.

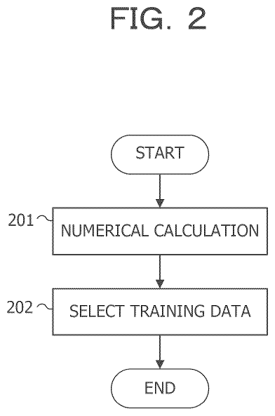

FIG. 2 is a flowchart illustrating an example of selection processing executed by the selection device 101 in FIG. 1. First, the calculation unit 111 obtains a relaxed structure of a substance from an initial structure of the substance by numerical calculation (step 201).

Next, the selection unit 112 selects an intermediate structure of which a difference between energy of the intermediate structure and energy of the relaxed structure is less than a predetermined value, as the training data used to train a machine learning model, from among the plurality of intermediate structures of the substance, obtained in a calculation process for obtaining the relaxed structure (step 202). The machine learning model estimates energy of a predetermined structure from the predetermined structure of the substance.

According to the selection device 101 in FIG. 1, it is possible to increase the number of pieces of training data of the machine learning model that estimates energy from a structure of a substance.

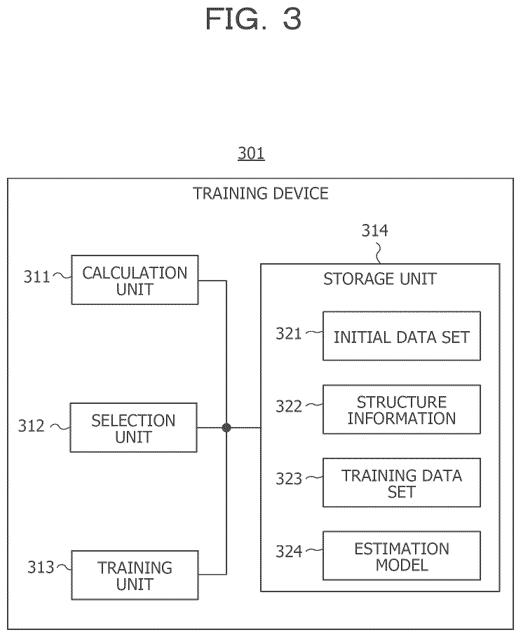

FIG. 3 illustrates a functional configuration example of a training device corresponding to the selection device 101 in FIG. 1. A training device 301 in FIG. 3 includes a calculation unit 311, a selection unit 312, a training unit 313, and a storage unit 314. The calculation unit 311 and the selection unit 312 respectively correspond to the calculation unit 111 and the selection unit 112 in FIG. 1.

The storage unit 314 stores an initial data set 321. The initial data set 321 includes initial data of a molecule of each of N substances (N is an integer equal to or more than one), and each initial data represents an initial structure of a molecule.

The calculation unit 311 obtains the relaxed structure from the initial structure represented by each piece of the initial data included in the initial data set 321, via the plurality of intermediate structures, by performing structural optimization using DFT calculation, generates structure information 322, and stores the structure information 322 in the storage unit 314. The structure information 322 includes a combination of each intermediate structure and total energy of each intermediate structure and a combination of the relaxed structure and total energy of the relaxed structure, for each of the N pieces of initial data. As the total energy of each structure, for example, a sum of potential energy of an atomic system is used.

By performing the structural optimization using the DFT calculation, it is possible to accurately obtain the relaxed structure of the molecule and to obtain the plurality of intermediate structures leading to the relaxed structure.

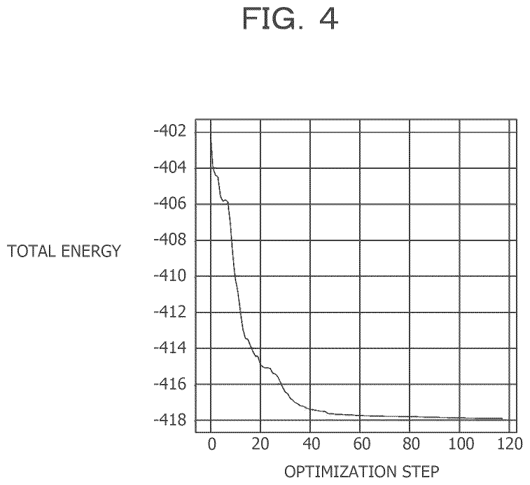

FIG. 4 illustrates an example of a change in total energy in the structural optimization. The horizontal axis indicates an optimization step, and the vertical axis indicates total energy of a molecular structure (electron volt). In each step, the intermediate structure and the total energy of the intermediate structure are calculated. The total energy sharply decreases in 0 to 30 steps and slowly decreases thereafter.

The selection unit 312 selects the combination of each relaxed structure and the total energy of each relaxed structure included in the structure information 322, as the training data. Moreover, the selection unit 312 selects a combination of the single or the plurality of intermediate structures having total energy close to the total energy of the relaxed structure, among the plurality of intermediate structures, and total energy of the intermediate structure, as the training data, for each relaxed structure included in the structure information 322. Then, the selection unit 312 generates a training data set 323 including the selected training data and stores the training data set 323 in the storage unit 314.

As a result, in addition to the relaxed structure, the single or the plurality of intermediate structures is selected as the training data. Therefore, the number of pieces of training data obtained by one DFT calculation increases, and the training data is expanded.

As the intermediate structure having the total energy close to the total energy of the relaxed structure, for example, an intermediate structure of which a difference between the total energy of the intermediate structure and the total energy of the relaxed structure is less than a predetermined value is selected. As such an intermediate structure, a final intermediate structure obtained immediately before the relaxed structure, at the time of structural optimization, may be selected. Note that, in a case where there is no intermediate structure of which the difference is less than the predetermined value, only the relaxed structure is selected as the training data.

The training unit 313 generates an estimation model 324, by performing machine learning for training the machine learning model before training, using the training data set 323 and stores the estimation model 324 in the storage unit 314. The estimation model 324 is a trained model and estimates total energy of a molecular structure, from the molecular structure of a substance to be estimated. As the estimation model 324, a neural network, a linear regression model, a random forest, or the like is used.

By training the machine learning model using the training data set 323 to which the intermediate structure is added, estimation accuracy of the generated estimation model 324 is improved, than that in a case where the training data set including only the relaxed structure is used. The estimation model 324 is used to estimate the total energy of the molecular structure, in various services such as material search, catalyst screening, or drug discovery.

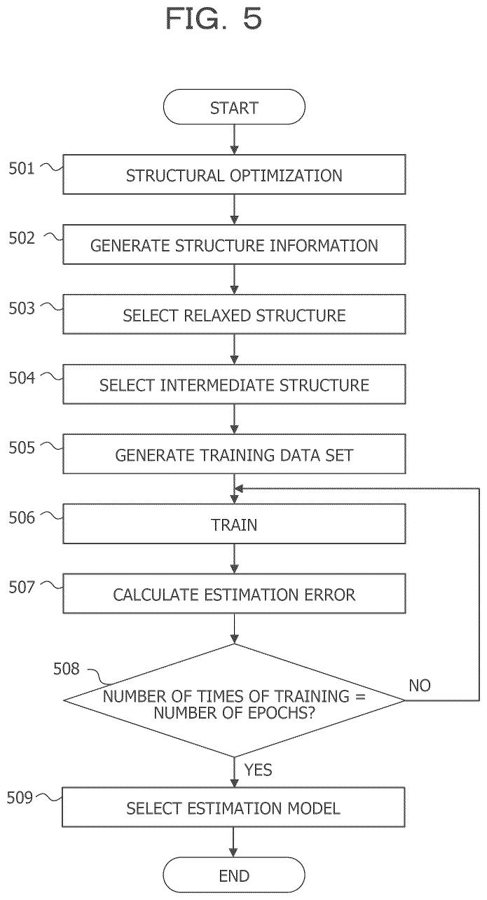

FIG. 5 is a flowchart illustrating an example of training processing executed by the training device 301 in FIG. 3. First, the calculation unit 311 obtains the relaxed structure from the initial structure represented by each piece of the initial data included in the initial data set 321, by performing the structural optimization using the DFT calculation (step 501) and generates the structure information 322 (step 502).

Next, the selection unit 312 selects the combination of each relaxed structure and the total energy of each relaxed structure included in the structure information 322, as the training data (step 503). Next, the selection unit 312 selects the combination of the single or the plurality of intermediate structures having the total energy close to the total energy of the relaxed structure, and the total energy of the intermediate structure, as the training data, for each relaxed structure included in the structure information 322 (step 504). Then, the selection unit 312 generates the training data set 323 including the selected training data (step 505).

Next, the training unit 313 generates the estimation model 324, by training the machine learning model using the training data set 323 (step 506). Then, the training unit 313 calculates an estimation error of the estimation model 324, using verification data (step 507).

Next, the training unit 313 compares the number of times of executed training and the number of epochs (step 508). In a case where the number of times of executed training is less than the number of epochs (step 508, NO), the training device 301 repeats the processing in and subsequent to step 506. In this case, in step 506, the training unit 313 further trains the estimation model 324 that has already been trained.

Then, in a case where the number of times of executed training has reached the number of epochs (step 508, YES), the training unit 313 executes processing in step 509, and the training device 301 ends the processing. In step 509, the training unit 313 selects the estimation model 324 having the smallest estimation error as an optimal estimation model 324, from among the estimation models 324 generated in the respective epochs.

Next, a specific example of the training processing will be described. In the specific example of the training processing, as the estimation model 324, a DFT proxy model PaiNN of Open Catalyst Project is used, and as the estimation error, a mean absolute error (MAE) is used. A training rate is 0.00001, and the number of epochs is 100. In this case, an estimation error ER of the estimation model 324 is calculated by the following formula.

ER=(1/K)Σ|y(i)−yp(i)| (1)

K is an integer equal to or more than one representing the number of pieces of verification data. Each verification data indicates a molecular structure. y(i) (i=1 to K) represents a correct answer of total energy of a molecular structure represented by an i-th piece of the verification data, and yp (i) represents an estimated value of total energy estimated from the i-th piece of the verification data by the estimation model 324. |y(i)−yp(i)| represents an absolute value of y(i)−yp(i), and Σ represents a sum for i=1 to K.

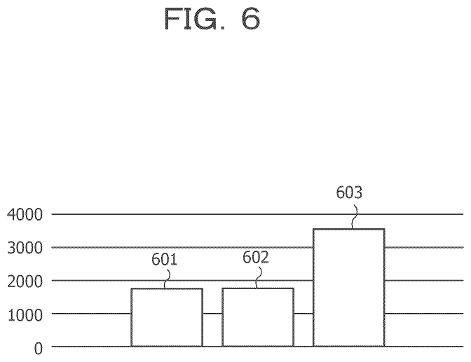

FIG. 6 illustrates an example of the number of pieces of training data. The vertical axis indicates the number of pieces of training data. A rectangle 601 represents the number N of pieces of initial data included in the initial data set 321. N represented by the rectangle 601 is 1780. A rectangle 602 represents the number of relaxed structures included in the structure information 322 generated by the DFT calculation from the initial data set 321. The number of relaxed structures represented by the rectangle 602 is 1780, which is the same as N.

A rectangle 603 represents the number of pieces of training data included in the training data set 323. In this example, an intermediate structure obtained immediately before the relaxed structure, among the intermediate structures included in the structure information 322 is selected as the training data. Since the number of intermediate structures having the total energy close to the total energy of the relaxed structure, among the intermediate structures immediately before the relaxed structure, is 1757, the 1780 relaxed structures and the 1757 intermediate structures are selected as the training data. Therefore, the number of pieces of training data represented by the rectangle 603 is 3537.

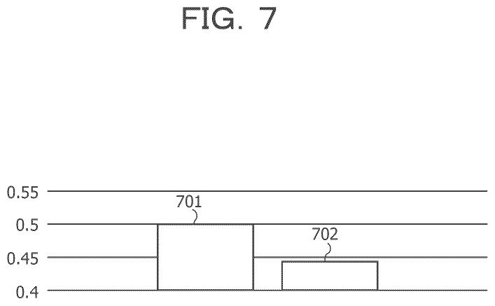

FIG. 7 illustrates an example of the estimation error ER. The vertical axis indicates the estimation error ER. In this example, the number K of pieces of verification data is 30. A rectangle 701 represents an estimation error ER in a case where the estimation model 324 is trained using only the 1780 relaxed structures represented by the rectangle 602 in FIG. 6 as the training data. The ER represented by the rectangle 701 is 0.5. A rectangle 702 represents an estimation error ER in a case where the estimation model 324 is trained using the 3537 pieces of training data represented by the rectangle 603 in FIG. 6. The ER represented by the rectangle 702 is 0.44.

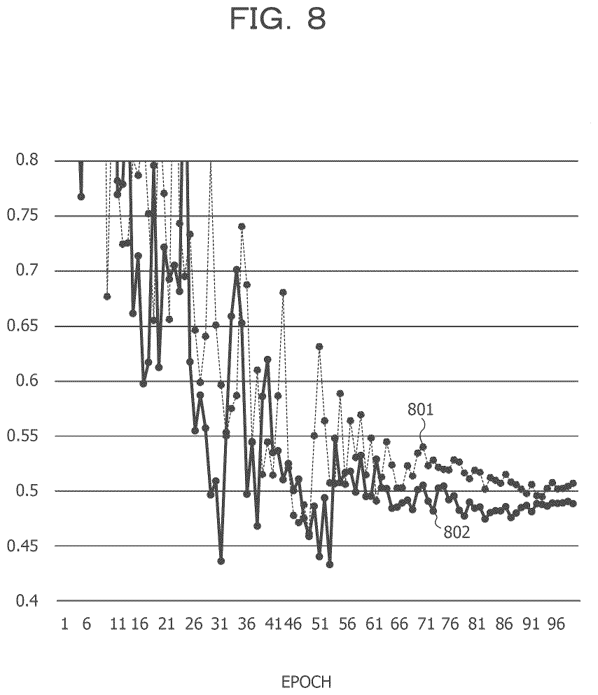

FIG. 8 illustrates an example of a change in the estimation error ER. The horizontal axis indicates the epoch, and the vertical axis indicates the estimation error ER. A broken polygonal line 801 represents a change in the estimation error ER in a case where the estimation model 324 is trained, using only the 1780 relaxed structures represented by the rectangle 602 in FIG. 6 as the training data.

A solid polygonal line 802 represents a change in the estimation error ER in a case where the estimation model 324 is trained using the 3537 pieces of training data represented by the rectangle 603 in FIG. 6. The ER represented by the rectangle 702 in FIG. 7 corresponds to a minimum value of the ER represented by the polygonal line 802.

From FIGS. 7 and 8, it can be seen that the estimation error ER is less than that in a case where training is performed using only the relaxed structure, by adding the intermediate structure to the training data set 323 to train the estimation model 324.

The configuration of the selection device 101 in FIG. 1 is merely an example, and some components may be omitted or changed according to applications or conditions of the selection device 101.

The configuration of the training device 301 in FIG. 3 is merely an example, and some components may be omitted or changed according to applications or conditions of the training device 301. For example, in a case where the machine learning model is trained by another device, the training unit 313 can be omitted.

The flowcharts in FIGS. 2 and 5 are merely examples, and a part of the processing may be omitted or changed according to the configuration or the condition of the selection device 101 or the training device 301. For example, in a case where the machine learning model is trained by another device, the processing in steps 506 to 509 in FIG. 5 can be omitted. In step 501 in FIG. 5, the calculation unit 311 may perform the structural optimization, using another numerical calculation instead of the DFT calculation.

The change in the total energy illustrated in FIG. 4 is merely an example, and the total energy changes according to a molecule to be calculated. The number of pieces of training data illustrated in FIG. 6 and the estimation errors illustrated in FIGS. 7 and 8 are merely examples, and the number of pieces of training data and the estimation error change according to the molecule to be calculated and a calculation condition.

The formula (1) is merely an example, and the training device 301 may calculate another error such as a square mean root error, as the estimation error of the estimation model 324.

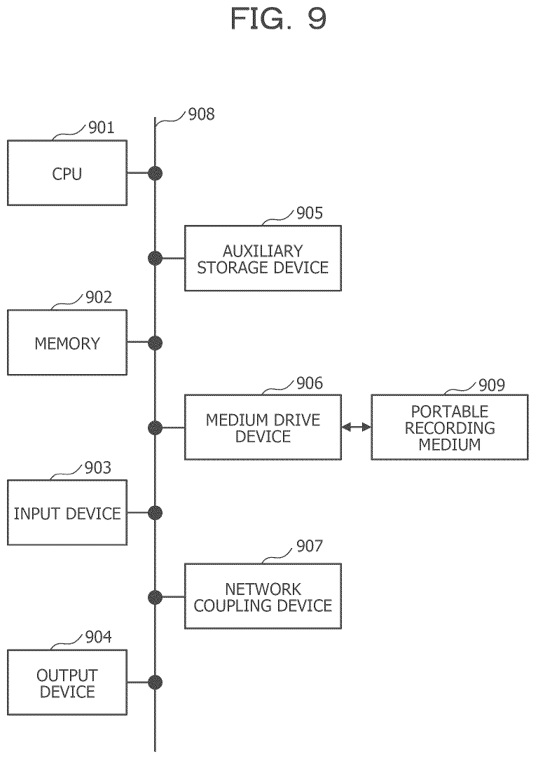

FIG. 9 illustrates a hardware configuration example of an information processing apparatus (computer) used as the selection device 101 in FIG. 1 and the training device 301 in FIG. 3. The information processing apparatus in FIG. 9 includes a central processing unit (CPU) 901, a memory 902, an input device 903, an output device 904, an auxiliary storage device 905, a medium drive device 906, and a network coupling device 907. These components are hardware and are coupled to each other by a bus 908.

The memory 902 is, for example, a semiconductor memory such as a read only memory (ROM) or a random access memory (RAM), and stores programs and data to be used for processing. The memory 902 may operate as the storage unit 314 in FIG. 3.

The CPU 901 (processor) operates as the calculation unit 111 and the selection unit 112 in FIG. 1 by, for example, executing a program using the memory 902. The CPU 901 also operates as the calculation unit 311, the selection unit 312, and the training unit 313 in FIG. 3, by executing a program using the memory 902.

The input device 903 is, for example, a keyboard, a pointing device, or the like and is used for inputting instructions or information from a user or an operator. The output device 904 is, for example, a display device, a printer, or the like and is used for outputting an inquiry or an instruction to a user or an operator, and a processing result. The processing result may be the training data set 323 or may be the optimal estimation model 324.

The auxiliary storage device 905 is, for example, a magnetic disk device, an optical disk device, a magneto-optical disk device, a tape device, or the like. The auxiliary storage device 905 may be a hard disk drive or a solid state drive (SSD). The information processing apparatus may store programs and data in the auxiliary storage device 905, and load these programs and data into the memory 902 to use. The auxiliary storage device 905 may operate as the storage unit 314 in FIG. 3.

The medium drive device 906 drives a portable recording medium 909, and accesses recorded content of the portable recording medium 909. The portable recording medium 909 is a memory device, a flexible disk, an optical disk, a magneto-optical disk, or the like. The portable recording medium 909 may be a compact disk read only memory (CD-ROM), a digital versatile disk (DVD), a universal serial bus (USB) memory, or the like. A user or an operator may store programs and data in the portable recording medium 909, and may load these programs and data into the memory 902 to use.

As described above, a computer-readable recording medium in which the programs and data used for processing are stored is a physical (non-transitory) recording medium such as the memory 902, the auxiliary storage device 905, or the portable recording medium 909.

The network coupling device 907 is a communication circuit that is coupled to a communication network such as a wide area network (WAN) or a local area network (LAN) and that performs data conversion pertaining to communication. The information processing apparatus can receive programs and data from an external device via the network coupling device 907 and load these programs and data into the memory 902 to use.

Note that the information processing apparatus does not need to include all the components in FIG. 9, and some components may be omitted depending on applications or conditions of the information processing apparatus. For example, in a case where an interface with the user or the operator is not needed, the input device 903 and the output device 904 may be omitted. In a case where the portable recording medium 909 or the communication network is not used, the medium drive device 906 or the network coupling device 907 may be omitted.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a selection program for causing a computer to execute processing comprising:
obtaining a relaxed structure of a substance from an initial structure of the substance by numerical calculation; and
selecting an intermediate structure of which a difference between energy of the intermediate structure and energy of the relaxed structure is less than a predetermined value, from among a plurality of the intermediate structures of the substance, obtained in a calculation process to obtain the relaxed structure, as training data used to train a machine learning model that estimates energy of a predetermined structure from the predetermined structure of the substance.

2. The non-transitory computer-readable recording medium according to claim 1, for causing the computer to execute processing further comprising: training the machine learning model by using a combination of the relaxed structure and energy of the relaxed structure and a combination of the selected intermediate structure and energy of the selected intermediate structure, as the training data.

3. The non-transitory computer-readable recording medium according to claim 1, wherein the numerical calculation is density functional theory calculation.

4. A selection device comprising:
a memory; and
a processor coupled to the memory and configured to:
obtain a relaxed structure of a substance from an initial structure of the substance by numerical calculation; and
select an intermediate structure of which a difference between energy of the intermediate structure and energy of the relaxed structure is less than a predetermined value, from among a plurality of the intermediate structures of the substance, obtained in a calculation process to obtain the relaxed structure, as training data used to train a machine learning model that estimates energy of a predetermined structure from the predetermined structure of the substance.

5. The selection device according to claim 4, wherein the processor trains the machine learning model by using a combination of the relaxed structure and energy of the relaxed structure and a combination of the selected intermediate structure and energy of the selected intermediate structure, as the training data.

6. The selection device according to claim 4, wherein the numerical calculation is density functional theory calculation.

7. A selection method comprising:
obtaining a relaxed structure of a substance from an initial structure of the substance by numerical calculation; and
selecting an intermediate structure of which a difference between energy of the intermediate structure and energy of the relaxed structure is less than a predetermined value, from among a plurality of the intermediate structures of the substance, obtained in a calculation process to obtain the relaxed structure, as training data used to train a machine learning model that estimates energy of a predetermined structure from the predetermined structure of the substance.

8. The selection method according to claim 7, further comprising:
training the machine learning model by using a combination of the relaxed structure and energy of the relaxed structure and a combination of the selected intermediate structure and energy of the selected intermediate structure, as the training data.

9. The selection method according to claim 7, wherein the numerical calculation is density functional theory calculation.
